(19) United States
(12) Patent Application Publication
(10) Pub. No.: US 2006/0249004 A1
(43) Pub. Date: Nov. 9, 2006

(54) Pure Tone and Beat Generator

(76) Inventors: Robert M. Bunker, Berthoud, CO (US); Thomas John McLeod, Loveland, CO (US)

Correspondence Address: GREENLEE WINNER AND SULLIVAN P C, 4875 PEARL EAST CIRCLE, SUITE 200, BOULDER, CO, 80301, US

(21) Appl. No.: 11/458,300

(22) Filed: Jul. 18, 2006

Related U.S. Application Data
(63) Continuation-in-part of application No. 10/738,822, filed on Dec. 17, 2003.
(60) Provisional application No. 60/700,620, filed on Jul. 19, 2005.

(51) Int. Cl. G10D 13/08

(52) U.S. Cl. 84/410

(57) ABSTRACT

This invention is for a percussion instrument that when struck produces a sustained tone. The instrument is shaped to produce a harmonious tone by tuning the appropriate overtones. The fundamental tone generated by the instruments disclosed herein are controllably tunable to within fractions of a hertz (Hz). Also disclosed are instruments that minimize and dampen unwanted overtones to generate a substantially pure tone. Also provided are related methods for generating a sustained tone as well as methods and devices for generating a beat, wherein a pair of the percussion instruments of the present invention having different tone frequencies provide the beat.

### CROSS-REFERENCE TO RELATED APPLICATIONS

This application claims the benefit of U.S. Provisional Application Ser. No. 60/700,620 filed Jul. 19, 2005 and is a continuation-in-part of U.S. application Ser. No. 10/738,822 filed Dec. 17, 2003, both of which are incorporated by reference in their entirety herein to the extent not inconsistent herewith.

### BACKGROUND OF THE INVENTION

Percussion instruments, when struck, produce a fundamental tone and associated overtones. The fundamental tone and overtones comprise the harmonic series. When a percussion instrument is struck, the fundamental tone is the strongest and lowest pitch and the overtones are higher and fainter pitches that occur above the fundamental tone. Overtones are also called harmonics or partials. The generation of overtones interfering with the fundamental tone when a percussion instrument is struck results in the perception that the fundamental tone changes with time.

The ability to design a percussion instrument substantially free of unwanted overtones is particularly important for generating sustained tones and for beat generation. A beat is generated when two tones of different, but very similar frequencies, interfere. Sound is propagated as waves. A pure tone, devoid of overtones, is a sinusoidal waveform having a frequency and time-dependent amplitude. Tone (pitch) is a measure of the wave frequency, and the amplitude of the wave is a measure of the sound's intensity. A higher frequency wave is heard as a higher tone or pitch. As known in the art, the waveform generated by two interfering sound waves of different frequency can be mathematically calculated by adding together the wave-equations that define the two individual waves. See, e.g., The Feynman Lectures on Physics (1963) 47-1 to 50-10. If the amplitudes of the two individual waves add, the interference is known as constructive interference. If the amplitudes of the two individual waves subtract, the interference is known as destructive interference. As known in the art, two pure tones of slightly different frequency interfere to generate a beat, wherein the beat frequency is equal to the difference between the frequencies of the two tones. The presence of substantial overtones in one or both of the tones adversely affects the quality of the beat, including varying the beat frequency over time.

Binaural beats are auditory brainstem responses that occur when one tone is presented to one ear, and another tone of a different frequency is presented to the other ear. In this situation the brain (specifically, the brainstem's superior olivary nucleus) perceives the binaural beat. The frequency of the binaural beat is the frequency difference between the two tones presented separately to both ears. A binaural beat can be useful for entraining brain waves. It is recognized that the brain has four separate levels of electrical signals, each corresponding to a separate frequency. Beta waves having a range of 12-24 Hz are dominant when the subject is alert; alpha waves (7-11 Hz) occur when a subject is relatively relaxed; theta waves (4-6 Hz) occur during daydreaming/light sleep; delta waves (less than 4 Hz) occur during deep sleep. There is a tendency for brain waves to entrain to the frequency of the binaural beat; therefore, a binaural beat can enhance specific brain-wave activity, thereby improving sleep, relaxation, and/or alertness. A beat with a particular beat frequency “x” can be generated by striking two tone generators whose difference in sustained tones is “x”. To obtain a 5 Hz beat frequency, for example, one device with a tone of 500 Hz, and another device with a tone of 505 Hz can be used. However, the precise values of the tone are not important, but instead the difference between the frequencies of the two tone-generators governs the binaural beat frequency. The constraints on the tone-generators are that they must be loud enough so that the tone is heard and the frequencies are preferably below about 1000 Hz so that the sound waves curve around the listener's skull. Any frequency can be used to generate a beat, even inaudible frequencies.

Beat generators are useful for meditation, hypnosis, assisting in leaning, improved sleep and relaxation. D. Brian Brady (1997) “Binaural-Beat Induced Theta EEG Activity and Hypnotic Susceptibility”; Atwater, F.H. (1997) “The Hemi-Sync Process”; U.S. Pat. No. 5,213,562.

There are devices known in the art that are useful for producing a beat. For example, the Zenergy Meditation Chime (The Peace Company, Bristol, VT) is made of two rods that are tuned to nearly the same pitch. Striking both rods results in a beat of approximately 12 Hz and is proposed to be useful in heightening sensory awareness and attention focusing at the start of meditation. However, this device suffers drawbacks because of the circular shape of the rods. Such a geometry results in vibration in all directions of the rod, with accompanying overtones, so that the tone produced by each rod is not substantially pure. Accordingly, the pitch is not sustained, and the primary beat arising from the fundamental tone, has conflicting underlying tones and beats. Accordingly, these devices generate substantial additional beats, wherein the additional beats interfere with the fundamental beat. The ability to precisely control beat frequency and to sustain a beat is important for a number of applications, including Chakra balancing and meditation. Although there is not a universally accepted Chakra frequency range for particular Chakras, one example of the frequencies for Chakra balancing is between 194.18 Hz and 8 Hz (Root), 210.42 and 9 Hz (Sacral), 126.22 and 10 Hz (Heart), 141.27 and 12 Hz (Throat), 221.21 and 13 Hz (Third Eye), 172.06 and 15 Hz (Crown). See binaural-beats.com (“Chakra Balancing CD”), information available at www.binaural-beats.com.

The field of vibrational healing (see, e.g., Richard Gerber, A Practical Guide to Vibrational Medicine: Energy Healing and Spiritual Transformation (2000) and Vibrational Medicine: The #1 Handbook of Subtle-Energy Therapies (3d ed. 2001); Olivea Dewhurst-Maddock, Book of Sound Therapy (1993)) requires instruments that can produce a substantially pure tone. A device known as a Quartz Singing Bowl is used in vibrational healing, wherein a bowl resonates at a certain tone that matches the tones of the chakras (root chakra (base)—C note; navel—D note; solar plexus—E note; heart—F note; throat—G note; brow (third eye)—A note; crown—B note). See Celestial Lights and Northern Lights, Ft. Collins, Colo. (http://www.celestial-lights.com). Frequencies ranging from between about 0.1 and about 10,000 Hz are believed to have useful biological and meditative applications. A percussion instrument that produces a substantially pure tone would be useful in the musical field. For example, a percussion instrument that produces a substantially pure, loud and sustained tone can replace the xylophone for tuning orchestras for correct pitch.

Percussion instruments known in the art do not produce a substantially pure tone because of the presence of significant overtones. This is further reflected in that when struck, the tones are generally not sustained. Xylophones, and other percussion instruments including the vibraphone, have a fundamental flaw in that after impact the pitch tends to rise as the tone decays. Variation in pitch with time results in an inability to maintain a steady beat. U.S. Pat. No. 4,543,871 for “Percussion Bar Instrument” has bars of varying length to generate a melody, but does not contain any means for minimizing overtones. Other devices do not dampen the overtones, but instead attempt to tune the overtones (U.S. Pat. Nos. 2,898,795 and 5,902,945) or generate overtones using additional paired faces (U.S. Pat. No.1,301,916). In general, striking percussion instruments shaped as pipes, bars or rods, as in U.S. Pat. Nos. 4,909,124, 6,005,177, and 3,896,696, results in production of substantial overtones that interfere with the generated tone. This invention addresses the need for percussion instruments to generate a sustained tone, with minimal associated unwanted overtones, wherein the pitch is sustained or maintained for long periods of time. In particular, the present invention permits the generated tone to be tuned very precisely, to within about 0.0001 to 0.001 Hz, and results in the tone being maintained for relatively long periods of time. The instruments of the present invention are particularly useful for generating a substantially pure tone that can be precisely tuned, a beat, and a binaural beat.

### SUMMARY OF THE INVENTION

The present invention provides a percussion instrument that generates a sustained tone for greater than at least one minute when struck. Specifically, the percussion instrument is a piece of resonant material that is generally shaped as an annular ring, with a portion of the outer surface of the annular ring flattened to form a base and a gap opposite the base. A resonant material is a material that vibrates when struck so as to produce an audible tone. The resonant material is not constrained to a precise annular ring, so long as the material produces a substantially pure tone when struck. Accordingly, the instrument can have a generally-curved shape including oval and ellipsoid, and the inner passage need not be exactly concentric with respect to the outer surface so long as a sustained tone is generated when the instrument is appropriately struck. This generally annular ring geometry having a base and gap is particularly advantageous in that it permits precise tuning of the instrument to obtain a frequency tunable on the order of 0.001 Hz and better, while simultaneously ensuring the tone is sustained for longer periods of time than presently available percussion instruments. In addition, the geometry permits any tone within, and even outside, the range of normal human hearing to be produced. Relatively long-sustained tone percussion instruments are useful in a number of fields including music generation, vibrational healing, meditation and beat generation.

More specifically, the shaping of the material results in tuning of wanted overtones to produce a harmonious tone. In other words, unwanted overtones are minimized. The result of the shaping is a generated tone when the instrument is appropriately struck that is aesthetically pleasing to the listener and sustained for relatively long periods of time, including greater than one minute, or greater than 5 minutes, or greater than 10 minutes, or greater than 20 minutes, or greater than one hour, without any discernable change in frequency of the tone to an ordinary listener. The amplitude of the tone decreases with time, but at a much slower rate of decay than percussion instruments known in the art, so that the tone can be heard for a relatively long period of time after the instrument is appropriately struck, including greater than one minute, or greater than 5 minutes, or greater than 10 minutes, or greater than 20 minutes, or greater than one hour.

In an embodiment, the percussion instrument is a shaped piece of resonant material that generates a sustained tone when struck, wherein the piece of resonant material is shaped as an annular ring. The annular ring has a portion of its outer circumference flattened to form a base. In addition, the annular ring also has a gap opposite the base that extends from the inner passage, through the ring to the outer circumference. This gap defines two symmetrical wings having opposed faces. In an embodiment, the opposed faces are curved. In an embodiment the opposed faces are flat surfaces. In an embodiment the opposed faces are parallel with respect to each other.

Any of the percussion instruments can be suspended or can sit on a surface. To ensure that the generated tone is maximally sustained, it is important that the instrument be appropriately suspended or appropriately situated on its base. Accordingly, the invention includes a nodal passage that is located at a nodal point and capable of receiving means for suspending the instrument, for embodiments wherein the instrument is suspended. The nodal point is located as disclosed herein. Means for suspending the instrument includes one pin tightly fit through the nodal passage, with a pair of chords, each chord attached to an end of the pin, running from a holder to the pin. Alternatively, the means can be a pair of pins with each pin protruding from one face, wherein a pair of cords each run to a different pin. In an embodiment, the pin is made of the same resonant material as the shaped piece of resonant material. In an embodiment, the pin is made of titanium. The means can also simply be a chord threaded through the nodal passage.

For a percussion instrument that is to rest on a surface, at least a pair of vibratory node lines is located on the bottom surface of the base. These lines can be identified by suspending the instrument base-side up, sprinkling the base with marker particles, striking the device to generate a vibration, and noting those regions that collect marker particles. As used herein, the “vibratory nodes” refers to nodal lines, extending the width of the base, which minimally vibrate compared to the magnitude of vibration at other base locations when the instrument is struck. To ensure a tone is maximally sustained, shallow grooves are generated along the vibratory node lines for receiving overtone dampers. The groove is of appropriate depth so that the base does not physically contact the surface, but rather makes physical contact only with the overtone dampers, thereby minimizing unwanted overtones. The overtone dampers located within the shallow grooves at the vibratory nodes on the bottom base surface can be composed of any material that can dampen vibrations, including for example, a rubber material such as a bungee cord. The damper is preferably at least as long as the width of the base and thick enough so that when the instrument with the damper is placed on a surface, the base does not directly contact the surface.

In an embodiment, the shaped piece of resonant material has an outer diameter, OD corresponding to the maximum diameter of the ring's outer circumference, and an inner diameter of the passage ID, and are related as:
ID=OD(π4)²

In an embodiment, the diameter of the inner passage is tapered. In an embodiment, the inner passage is tapered from a value of ID to less than ID at a taper angle of about 10° and at the other face at a taper angle of about 45°. In an embodiment the inner passage has a single taper having a taper angle in between about 10° and 45°. Each of the two wings has an end face that faces, but does not touch the other, such that a gap is formed between the ends. In an aspect of the invention, the wings are shaped so that their top surfaces, which define the top edge of the percussion instrument, are curved in two orthogonal directions. The inner surface that defines the inner passage can be similarly curved. The inner passage, however, can be tapered such that the effective diameter of the inner passage varies with the distance from the front surface of the instrument. The geometry of each wing can be symmetrical with respect to the other. In addition, the width and thickness of the wing can be substantially equal, so that the maximum width of the base, T is given by T=0.5(OD-ID).

The resonant material is any material that resonates when struck and produces an audible tone. Preferably the material is a resonant metal, including brass, bronze, aluminum, gold, silver, platinum, titanium, and can also be laser-formed silicon, wood or any other resonant material.

The sustained tone produced by the percussion instrument can be of any frequency, and preferably is a frequency in the auditory range of humans (e.g. about 16 Hz to 20,000 Hz). The frequencies generated are preferably notes of the standard musical scale, but can be of any audible frequency. Once an instrument has been constructed and emits a sustained tone when struck, the sustained tone can be further optionally tuned by a variety of means. For example, gentle abrasion of the bottom surface of the base results in a lower frequency sustained tone (e.g. a lower pitch), while gentle abrasion of the wing end faces increases the frequency of the sustained tone (e.g., a higher pitch). In this manner the fundamental tone can be precisely tuned. This means of tuning via selectively abrading different regions of the instrument is particularly useful because the frequency of a metal percussion instrument varies with the temperature of the metal. Because a colder piece of resonant metal resonates at a higher frequency than when the metal is warmer, the instrument can also be tuned by varying the temperature of the shaped piece of resonant metal.

The sustained tone produced by the percussion instrument is also dependent on the shaped material's geometry and size. In general, larger size instruments produce a lower tone. For a hand-carried percussion instrument, the base length can be any size desired, e.g., it can range from between about 3 cm and about 100 cm in length, and the base width can be any size desired, e.g., between about 0.5 cm and about 20 cm. The invention also encompasses instruments that are larger than this range, e.g., the size of church bells and other large public bells. The percussion instruments of the present invention can be of any mass, depending on the composition of the resonant material and the tone to be sustained, but are generally between about 50 g and 13 kg.

In an embodiment, the percussion instrument is shaped to produce a harmonious tone. A tone is harmonious, as known in the art, when an instrument produces a fundamental tone and overtones tuned to a 1:3:5:1 ratio. In other words, the 3^{rd}, 12^{th}, and 15^{th} notes above the fundamental are tuned (see FIG. 1C). Although other overtones may be present, the overtones are substantially restricted to the third note, fifth note and two octaves above the fundamental. As known in Western music theory, such overtones result in an aesthetically-pleasing note. The instruments can be similarly shaped to generate other overtones that result in a harmonious tone for other (e.g., non-Western) musical scales.

Another embodiment of the present invention is a method of generating a substantially pure tone by striking any of the present invention's percussion instruments. The striking can be done by a person physically striking the side or top edge of the instrument with a striker, or can be by an automated striker.

The invention also provides a method for generating a beat, including a binaural beat. A beat is generated by appropriately positioning two percussion instruments of the present invention having different sustained tones so that the frequencies interfere with one another. The frequency of beating is dictated by the difference in frequency between the two tones. In this manner, the invention provides a means for generating a beat with any frequency. The spacing between the instruments is not important, so long as both are audible to the listener. Temperature tuning can be combined with beat generation so as to provide the ability of one single pair of percussion instruments to generate a wide range of beat frequencies.

For binaural beat generation, the sustained tones should be less than about 1000 Hz. Beat frequencies that match brain-wave states (e.g. less than about 35 Hz) are particularly useful to assist in meditative states, restfulness, wakefulness, assisting in sleep, and/or assisted learning. Useful beat generators have frequency difference less than about 500 Hz with the first sustained tone less than about 1000 Hz and the second sustained tone less than about 1000 Hz. The beat generator can have a frequency difference between the first sustained tone and the second sustained tone that is greater or equal to 12 Hz and less than or equal to 24 Hz, or greater or equal to 24 Hz and less than or equal to 43 Hz, or greater or equal to 7 Hz and less than or equal to 12 Hz, or greater or equal to 4 Hz and less than or equal to 7 Hz. In an embodiment, the beat generator has frequency difference between the first sustained tone and the second sustained tone less than or equal to 4 Hz.

The percussion instruments of this invention can be used for meditation and healing, and a single instrument can be used as a single tone generator, e.g., for voice pitch training, as tuning forks, and as musical instruments.

### BRIEF DESCRIPTION OF THE DRAWINGS

FIG. 1A is a front view schematically illustrating the general shape for one embodiment of the percussion instrument. B is a side view of the wing face that forms one side of the gap. C shows musical notes, in particular the fundamental tone generated when an instrument is struck and corresponding overtones (third, octave+5 and two octaves) that are tuned to generate a harmonious tone.

FIG. 2 is a series of photographs of the percussion instrument depicted in FIG. 1. A is a close-up view of a percussion instrument. B is a top-front view photograph of four sets of paired percussion instruments. The instruments of each pair are tuned such that there is a fundamental frequency difference of a selected hertz value between them. In general, the larger the instrument, the lower the fundamental frequency. Each pair can be struck to generate a beat. C is an oblique-view photograph of the instruments in B.

FIG. 3 shows a percussion instrument of the present invention suspended from a stand.

FIG. 4 is a side view of the embodiment depicted in FIG. 3.

FIG. 5 shows a rear view of the percussion instrument of FIG.3 without the stand and associated suspension means.

FIG. 6 is a schematic illustrating mathematical relationships for generating preferred dimensions and shapes of the percussion instrument.

FIG. 7 illustrates a geometrical schematic of a percussion instrument.

FIG. 8 illustrates a temperature regulator connected to a percussion instrument for tuning the fundamental frequency.

### DETAILED DESCRIPTION OF THE INVENTION

The invention may be further understood by the following non-limiting examples. Although the description herein contains many specificities, these should not be construed as limiting the scope of the invention but as merely providing illustrations of some of the presently preferred embodiments of the invention. For example, thus the scope of the invention should be determined by the appended claims and their equivalents, rather than by the examples given. Thus, additional embodiments are within the scope of the invention and within the following claims. All references cited herein are hereby incorporated by reference to the extent that there is no inconsistency with the disclosure of this specification. Some references provided herein are incorporated by reference herein to provide details concerning additional materials that can be used in the invention, additional methods of making the invention, and additional uses of the invention.

The invention comprises a piece of shaped resonant material. The particular composition of the material is not critical, so long as the material resonates when struck. Accordingly, any material that can be shaped and that resonates when struck can be used. For example, the material can be metal or quartz. In a preferred embodiment the material is a resonant metal, including aluminum, brass or stainless steel. The aluminum or brass compositions are preferably not cast, but instead machined so as to maintain the direction of the grain. The particular direction of the grain relative to the shaped piece is not important.

The general shape of the resonant material is constrained by the requirement that a substantially pure tone be produced. A tone is “substantially pure” if the tone sounds “organic”, i.e., there are minimal overtones, compared to a “pure tone” devoid of overtones, such as a pure sine wave. As used herein, a “pure tone” is one that is devoid of overtones, and is therefore a pure sine wave. Such a pure tone can be electronically synthesized. In contrast, a “substantially pure tone” has a richer sound than a “pure tone” and sounds organic because of the presence of some overtones. The unwanted overtones of this invention are, however, dampened and minimized so that the fundamental tone is sustained. Sustained refers to the tone carried for a longer time without decaying or varying in frequency compared to a percussion instrument that does not generate a substantially pure tone. Generally, the percussion instruments of this invention can sustain a substantially pure tone for on the order of 60 seconds or more without substantial decay in the quality (e.g., frequency and amplitude) of the fundamental tone when the percussion instrument is solidly struck on the outward-facing surface of the wings. As used herein, “sustained” with respect to a “sustained tone” refers to the frequency remaining substantially unchanged for at least one minute after the instrument is struck, and up to more than five minutes, or more than 10 minutes, or more than 15 minutes, or up to an hour or more. Although the amplitude of the tone decays, it decays less quickly than other percussion instruments known in the art and is audible over the time ranges disclosed herein. “Substantially unchanged” refers to an ordinary listener not being able to distinguish a change in quality of the tone (e.g., the frequency) over the specified time. The length of time the tone is sustained depends on the mass and size of the percussion instrument, with larger instruments carrying the tone for a longer time. For example, an aluminum percussion instrument of the present invention having an outer diameter of about 12 inches sustains a tone for about 20 minutes when the outward-facing surface is struck. A substantially pure tone generated for long time periods, without a substantial variation in frequency is particularly beneficial for generation of a high quality beat or binaural beat.

Harmonics (e.g. overtones) can be detected as known in the art, so that the fundamental tone, along with associated overtones that vibrate sympathetically above the frequency of the fundamental, can be assessed in terms of amplitude, frequency and duration. The geometry of the percussion instruments of the present invention is important for generation of a sustained tone of a precise frequency when the percussion is appropriately struck. The instrument can rest on a flat surface or be suspended from a holder.

Base-Resting Percussion Instrument:

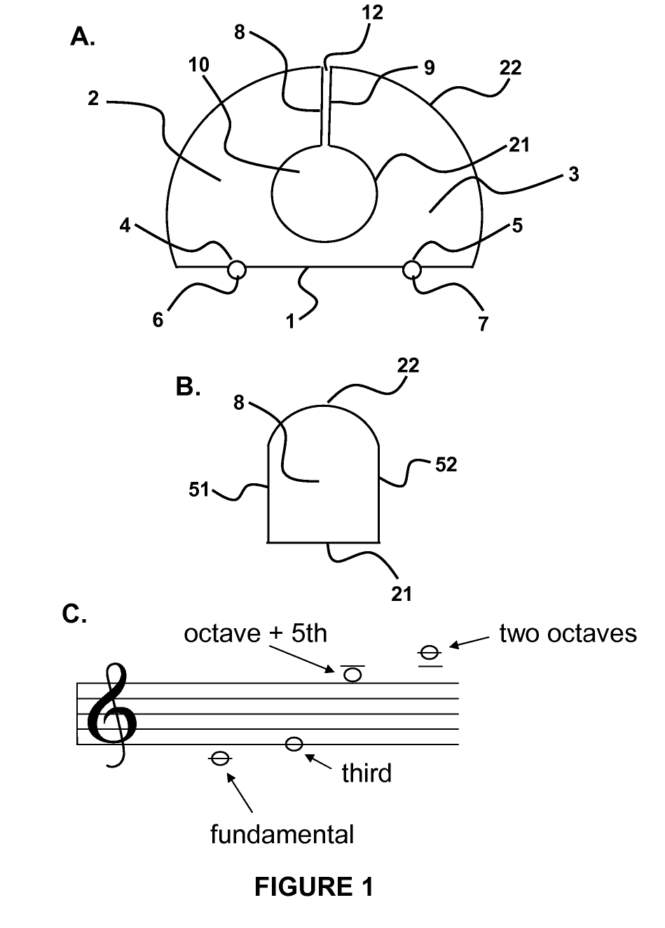

The base-resting embodiment of the percussion instrument is schematically illustrated in FIG. 1. FIG. 1A provides a frontal view of the shape. For this embodiment, where the instrument rests on a surface, overtone dampers 6 and 7, placed within grooves 4 and 5 located on the base 1 of the instrument ensures a relatively rapid decay of associated overtones compared to traditional percussion instruments. This improvement can be audible to a person striking the instrument, and can be detected using harmonic detectors, as known in the art. The instrument's bottom is a substantially flat base 1 from which two wings 2 and 3 extend. Each of the wings can have an end face 8 and 9. In this embodiment, the wings curve up from the base so that the ends 8 and 9 face each other and are separated by a gap 12. The width of the gap must be close enough to sustain the tone but not so close as to generate interference and stifle the ability of the instrument to generate a tone. Generally, the faces 8 and 9 are separated by between about ⅛″ (3 mm) and ¾″ (19 mm), depending on the size of the instrument. In this embodiment, the outer surface 22 and inner surface 21 of the instrument are substantially circular-shaped, so that the shaped piece of resonant material is generally an annular ring. The inner passage 10 of the annular ring is defined by the inner surface 21 of the wings. A portion of the outer surface 22 of the annular ring is substantially flattened to form a base 1, opposite gap 12. The base 1 has a length and width. The base 1 can have a pair of shallow grooves 4 and 5, located at the vibratory nodes of the instrument, and running the width of the base. A pair of overtone dampers 6 and 7 can be located within the grooves 4 and 5. The instrument is set upright on its base with dampers in the grooves so that the dampers absorb and minimize overtones. A substantially pure tone, having a sustained tone, is generated when the outer surface 22 is struck by a striker. The striker can be user generated or, alternatively, can be an automated striker. To generate a substantially pure tone, wherein the tone is carried for a relatively long time, the material is struck on the outward-facing surface of 2 and 3 (e.g., surface 22). The vibrations producing the fundamental tone of the struck device of FIG. 1 generally emanate from the outward-facing surface of wings 2 and 3. Although a tone is generated when other locations besides 22 is struck, those tones are not sustained.

In addition to being curved in the direction shown in FIG. 1A (e.g. from a front view perspective), the top surface is also curved in the orthogonal direction (e.g. from a side view perspective), as shown in FIG. 1 B. FIG. 1 B is a side view of the wing face 8 showing the outer surface 22 having a radius of curvature, Rₜ., and a flat inner surface 21. In addition, inner surface 21 is optionally tapered to form one or more lines having a slope, or a curved line. The embodiment shown in 1 B has an inner surface 21 of zero slope. The front and back surfaces of wings 2 and 3 can also be curved, with a radius of curvature R_{w}, or can be flat. FIG. 1C illustrates that the percussion instrument can be shaped so as to produce a fundamental tone and overtones that are tuned to the fundamental, so as to produce a harmonious tone.

The vibratory nodes can be located as disclosed in U.S. pat. app. Ser. No. 10/738,822, hereby incorporated by reference. Vibratory nodes are the locations on the material base that minimally vibrate. The nodes can be located by suspending the device with string, base up, sprinkling the base with marker particles such as sawdust or table salt, striking the device causing vibration, and locating the nodes as those regions that collect the marker particles. In this manner, the node locations are marked, and grooves 6 and 7 are formed into the base at the nodes, running the width of the base, for receiving the overtone dampers 6 and 7.

Overtone dampers 6 and 7 can be any material that can dampen vibration. In a preferred embodiment the dampers are made from rubber. The device is placed on a flat surface such that only the dampers 6 and 7 touch the flat surface. Because the dampers 6 and 7 are located at the vibratory nodes, they have a minimal affect on the fundamental frequency, while dampening overtones, thereby ensuring the device generates a substantially pure tone that is sustained when appropriately struck.

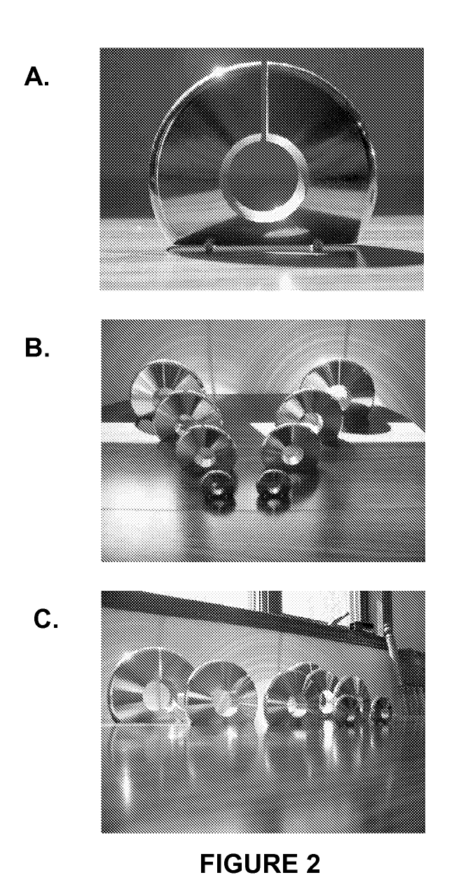

FIG. 2 contains a series photographs of percussion instruments made of shaped aluminum. As shown in FIG. 2A, the inner passage of the annular ring, defined by the inner surface, can be optionally tapered so that the opening is larger on the front face compared to the back face of the instrument. FIG. 2 also shows that the base of the instrument rests on overtone dampers so that the base does not physically contact the surface upon which the instrument rests. FIGS. 2B and 2C provide views showing the overall 3-dimensional shape of an embodiment of the present invention. In general, the shaped resonant material has a flat base, whose width is less than its length, and a relatively thin side profile compared to the base's length and the instrument's height.

Hanging Percussion Instrument:

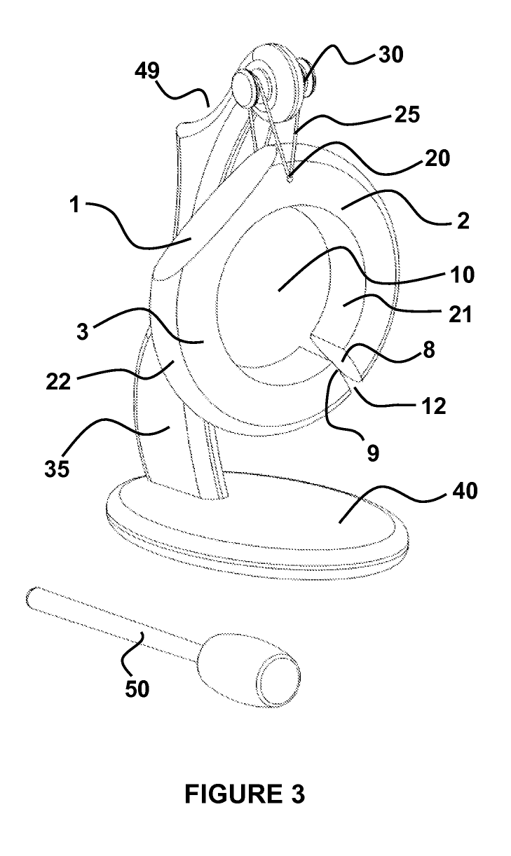

FIG. 3 illustrates an embodiment wherein the percussion instrument, having an annular ring shape, is suspended or hangs from a stand 49. The percussion instrument has a gap 12 opposite from a base 1 from which a pair of wings (2, 3) extend. The wings have an inner-surface 21 that define the geometrical edge of passage 10, an outer-surface 22, and opposed faces (8, 9) that define geometry of gap 12. A hole 20 through the thickness of the percussion instrument is for receiving means for suspending the percussion instrument. In one embodiment, the means for suspending the percussion is a nodal pin to which cord 25 is attached. The nodal pin can be a single pin to which a cord attaches at each end. The nodal pin can be two pins, with one pin extending from the front face and the other pin extending from the back face, with a cord attached to each end. Alternatively, cord 25 can be placed directly through hole 20 without attaching to nodal pin. The cord 25 engages stand 49 so that the percussion instrument is suspended in the air with the only physical connection at cord 25 with hole 20 or nodal pin placed in hole 20. The stand can comprise base 40 attached to one end of holder arm 35, with the other end of arm 35 connected to a means for mounting or holding cord 25. To minimize rotation of the percussion instrument when struck by a striker 50, FIG. 3 illustrates the cord 25 having two loops, with each loop placed over a mount 30 on either side of arm 35. To generate a sustained tone, a striker 50 is used to strike the curved portion of outer surface 22.

A percussion instrument can have features for both sitting on a surface (e.g., grooves on the base at vibratory nodes) and a hole 20 for receiving means for suspending. Such an instrument has an increased versatility so that when traveling, for example, a stand 49 is not required to be transported. Instead, the instrument can be placed on a surface, with an overtone damper placed in each groove.

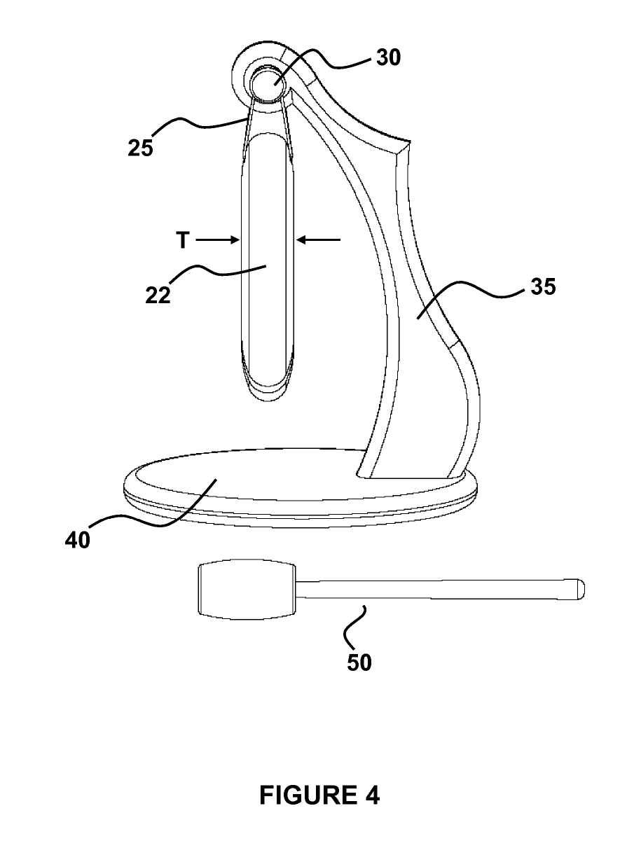

FIG. 4 is a side view of FIG. 3, where the percussion instrument hangs perpendicular with respect to the base 40. Stand arm 35 has a curved edge to minimize the chance of the percussion instrument physically contacting the stand 49, thereby ensuring the fundamental tone is sustained after striking the outer surface 22 of the percussion instrument with the striker 50.

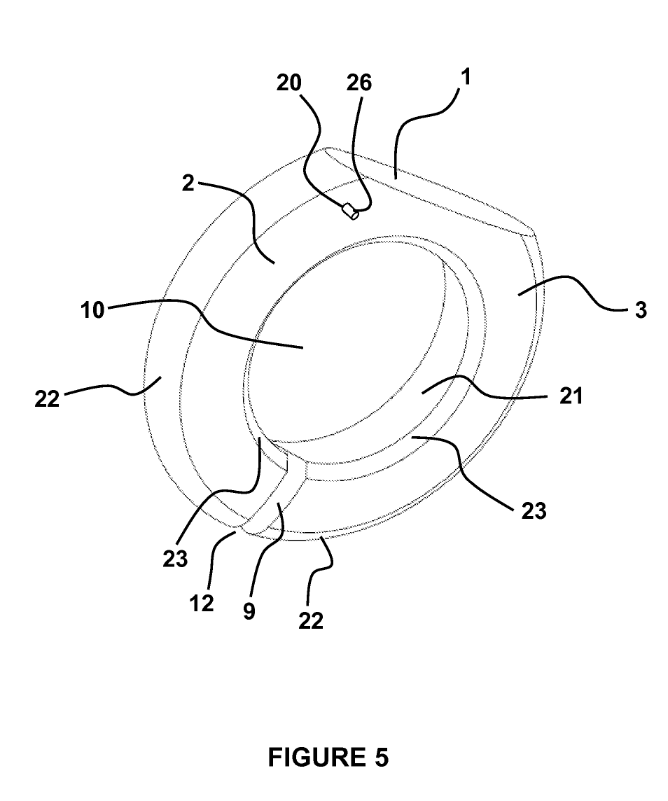

For clarity, FIG. 5 shows a view of a percussion instrument without the stand 49 or cord 25. The instrument is similar to the one shown in FIG. 1, except that the wings 2 and 3 have two inner-facing surfaces 21 and 23 that make up the outer surface of passage 10. Such an inner passage is said to be “tapered.” As shown in FIG. 5, passage 10 can have cross-sectional area that varies with position along the central-axis of the instrument (e.g., the perpendicular line centered on the center of the instrument). A means for suspending the percussion instrument comprising a nodal pin 26 located within hole 20 is shown. The pin extends past front and rear face of the instrument, with each end connecting to a suspending chord. For the embodiment where a nodal pin is placed within hole 20, the hole 20 diameter is drilled such that it has a diameter on the order of 0.001 inches less than the diameter of the nodal pin, so that a tight-fit is formed between pin 26 and hole 20 when the pin is placed within the hole.

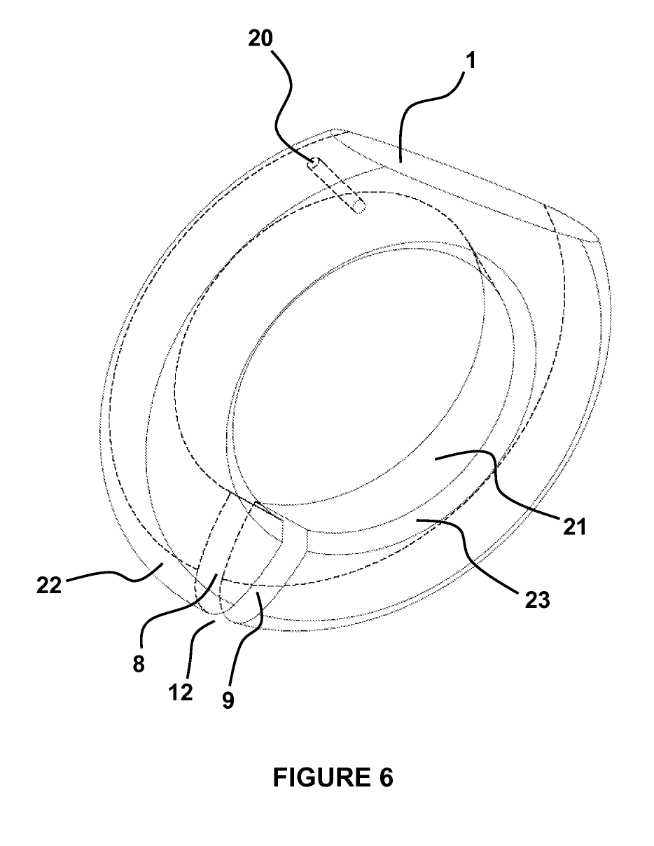

FIG. 6 uses dashed lines to show surfaces hidden from the view shown in FIG. 5. In particular, it shows that a nodal passage or hole 20 traverses the thickness of the instrument and that wing end surfaces 8 and 9 face one another with the surfaces being parallel with respect to one another.

The instrument's particular shape is not important so long as the instrument generates a tone of a specific frequency that is sustained when struck. Accordingly, the invention encompasses shapes other than the embodiment depicted in the figures. For example, the base need only be substantially flat. As used herein, substantially flat refers to a base that can rest on overtone dampers without any portion of the base directly contacting the surface upon which the dampers rest. Other variations in the shape are encompassed by the present invention, including an inner passage that is not circular-shaped. The inner passage can be shaped as an ellipsoid, or can have corners, so long as the shape does not result in production of overtones that are not relatively rapidly dissipated by the overtone dampers. Accordingly, the free ends of the material that define gap 12 need not face each other separated by a uniform space, nor does the top edge of wings 2 and 3 need to be strictly circular-shaped. Instead, the particular shape is constrained by the desired fundamental tone frequency and quality and magnitude of specific overtones with time, as well as general aesthetic considerations.

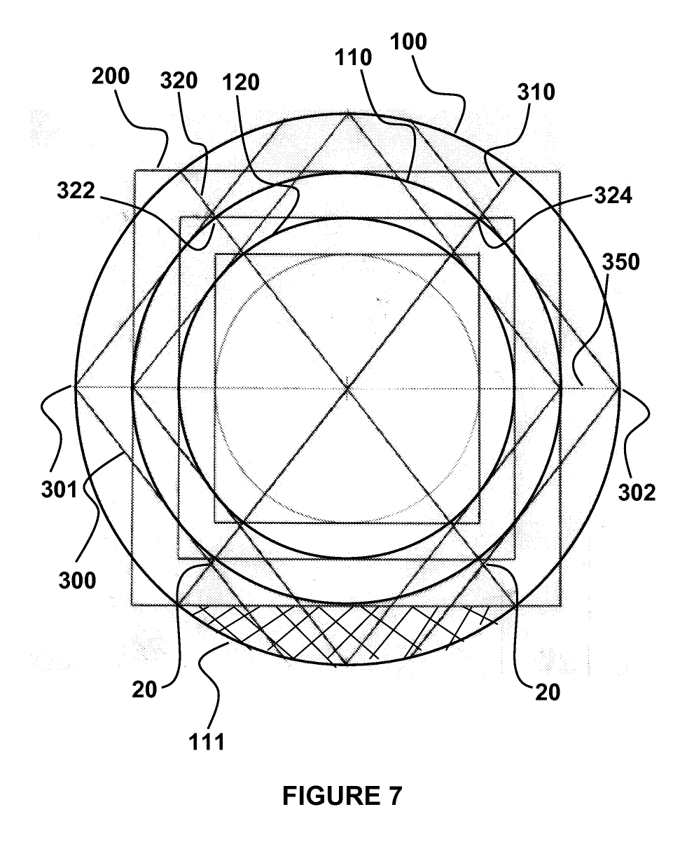

A preferred geometry of the percussion instrument utilizes the geometry schematically outlined in FIG. 7. Such geometry, referred to as the “sacred geometry,” maximizes the sustainability of a generated tone. The outer surface 22, of the instrument follows the circumference of outer circle 100, having diameter OD. Outer square 200 is constructed to have a perimeter equal to outer circle 100, so that:
4L=πOD,

Where L is the length of one side of square 200 and OD is the diameter of circle 100.

The next inner circle, 110 is related to outer circle 100 by inner circle having diameter Dᵢₙₙₑᵣ that is related to Dₒᵤₜₑᵣ by the following equation:
Dᵢₙₙₑᵣ=(π/4)Dₒᵤₜₑᵣ

Each of an adjacent pair of circles follows this relationship. Inner passage surface 21 of the percussion instruments of the present invention is represented by circle 120. Accordingly, for a given outer diameter of the percussion instrument (“OD”), the diameter of the inner passage (ID) is:
ID=(π/4)²OD

The outer circumference of the instrument, represented by surface 22 and circle 100 is partially flattened to form base 1. The base preferably follows a side of square 200 so that the depth of material to be removed from circle 100 to form base 1 is (as represented by hatched region 111):
(OD−L)/2=(1−π/4)OD/2=0.107OD

Finally, for the hanging embodiment nodal hole 20 is located by constructing diamond 300 with two opposite vertices intersecting circle 100 at points 301 and 302. The angle of the diamond vertex at point 301 and 302 is about 103° degrees (e.g., two times 51.5126° with respect to the horizontal line 350 drawn through the circle center). The nodal point is the intersection between diamond 300 and line 310 or line 320. Lines 310 and 320 are similarly generated by drawing a line through the circle origin having an angle of 51.5° relative to horizontal line 350. In a preferred embodiment, the nodal hole is located at or near at least one of the two nodes located between the inner passage and the base. In an embodiment, a nodal hole is located at or near one of the two nodes located between the inner passage and the top of the instrument (322 and 324).

For the embodiment where the instrument rests on a surface, the vibratory nodes are generally located below nodal hole 20 and can be empirically verified by using the sawdust technique as disclosed hereinabove.

The front and back surfaces of the percussion instrument can be curved. Generally, the thickness of the percussion instrument, T, is equal to about half the difference between the outer diameter and inner diameter of the ring annulus.

The human range of hearing is normally from about 16 to about 20,000 Hz. Accordingly, the tones produced by the devices of the present invention can range from between 20 Hz and 20,000 Hz, or from between 20 Hz and 3,000 Hz. However, in a preferred embodiment tones are generally in the range reflecting common musical scales, e.g., about 20 Hz to 8,000 Hz, between about 20 Hz to about 1000 Hz, and all sub-ranges in between, such as 12 Hz to 24 Hz, 7 Hz to 11 Hz, 4 Hz to 6 Hz, and less than 4 Hz.

As used herein, beats refer to the pulsing tone arising from interference between two substantially pure tones generated by the percussion instruments of the present invention. A “binaural beat” is a beat processed as an auditory brainstem response when the ears receive two different frequencies at the same time. In one embodiment a different frequency is presented to each ear. An auditory brainstem response in the superior olivary nucleus of each hemisphere in the brain processes the two separate signals as a beat with a frequency equal to the frequency difference between the two signals. The tones generated by the instruments of the present invention can be recorded, so that during stereo playback a binaural beat is generated. Alternatively, the instrument pair can be positioned to provide a stereo effect so that separate tones are presented to each ear, thereby generating a binaural beat.

The particular size of a percussion instrument (e.g. see FIG. 2C) is constrained by the tone (e.g. frequency) to be produced. Instruments that are equivalent in shape, but are relatively larger in size, generate a tone when struck that has a relatively lower frequency (i.e. a “lower” tone) compared to a smaller instrument. In addition, the composition of the shaped material will also affect the tone. For example, a piece of aluminum when struck resonates at a different frequency compared to a piece of brass when struck. In particular, a piece of brass of similar size and shape to a piece of aluminum will resonate at about an octave lower than the aluminum piece. Accordingly, to obtain a percussion instrument with a lower fundamental tone, brass can be used if a smaller instrument is desired. Although aluminum can also be used, the percussion instrument will be correspondingly larger and heavier in order to generate the lower fundamental tone. The present invention encompasses a series of differently sized instruments so as to provide a musical scale, including a standard musical scale. For example, the 12-tone musical scale can be reproduced with 12 separate appropriately sized percussion instruments with equivalent shapes. Of course, any number of percussion instruments, each having a fundamental tone, can be provided so as to generate any Western or non-Western musical tone or scale. In general, the denser the object, the lower the fundamental tone.

By employing a logarithmic musical formula, the pitch of the tone is doubled by halving the mass of an instrument. Furthermore, musical ratios permit generation of any musical note based on the dimension of one bell generating a tone that is a musical note. For example, Table 1 shows a method whereby when a single percussion instrument is constructed having a note, the dimensions of other percussion instruments can be calculated so as to obtain an entire musical scale. In the example shown in Table 1, the notes on a piano scale are given in the first and second columns, with the corresponding frequency in Hertz in the column labeled “Freq.” In this example, a percussion instrument having the note G4 (piano note 47) is constructed of aluminum. The instrument is appropriately tuned by the methods disclosed below to obtain a frequency when struck of 391.995 Hz. The outer diameter of the instrument is 9.538 inches. Using the relationships disclosed herein, the inner diameter (column labeled “ID”) is about 5.896 inches. The column labeled width refers to the width maximum between the front and back wing faces (see arrows in FIG. 4) and is generally given by W=0.5(OD-ID). The width and thickness of the wings 2 and 3 are generally about the same. The column labeled FILLET 1 and FILLET 3 refer to an optional face radius, wherein there is a curve to the front and back instrument faces. This radius of curvature can be about the difference between OD and ID. FILLET 2 is the end radius reflecting that the outer surface 22 has an orthogonal curve. FILLET 2 is obtained by blending the orthogonal curvature of surface 22 with the curvature of the front and back instrument faces. FILLET 2 also is the gap distance between the faces of the two wings.

Other instruments can be constructed that generate different notes using a single instrument that generates a pitch that is a note, by employing ratios of the notes. For example, in the 12-note scale shown in Table 1, an instrument that sustains note 48 (G#₄) is obtained by multiplying each of the dimensions of note 48 by 2^{1/12}. Similarly, note 47 (F#₄) is obtained by dividing each of the dimensions of note 48 by 2^{1/12}. Any note is accordingly obtained by appropriate multiplication of the known dimension by 2^{n/12}, where n is the number of steps and half-steps from the sustained note generated by the constructed instrument. Accordingly, a change in one octave corresponds to a doubling (to half the frequency) or halving (to double the frequency) of the dimensions. In this manner, a series of percussion instruments can be made to generate any musical scale.

Tuning:

An advantage of the shapes depicted herein is that the sustained tone can be readily tuned. The material is shaped, e.g., by machining, to a desired pitch, or preferably slightly above the desired pitch. The pitch can be slightly lowered by abrading the bottom of the base 1. This abrasion can be accomplished by gently rubbing the base bottom with coarse paper so that a very small amount of the instrument is removed. As an example, running sandpaper gently back and forth over the base can decrease the frequency by as little as 0.00001 Hz and as much as about 100 Hz in larger-sized instruments. In addition, the frequency can be increased (e.g., the pitch can be raised) by between about 0.001 Hz to about 50 Hz, depending on the size of the instrument by abrading the wing ends 8 and/or 9.

The sustained tone can also be tuned by changing the thickness of the shaped material, changing the geometry of the hollow portion 10, including tapering or not tapering the edge of the hollow, varying the slit spacing and/or the slit geometry. In addition, these geometrical changes can also affect the harmonics of the resonating material by producing different overtones that are then rapidly damped. Because different metals resonate at different frequencies, identical instruments constructed from different metals generate different tones and overtone series.

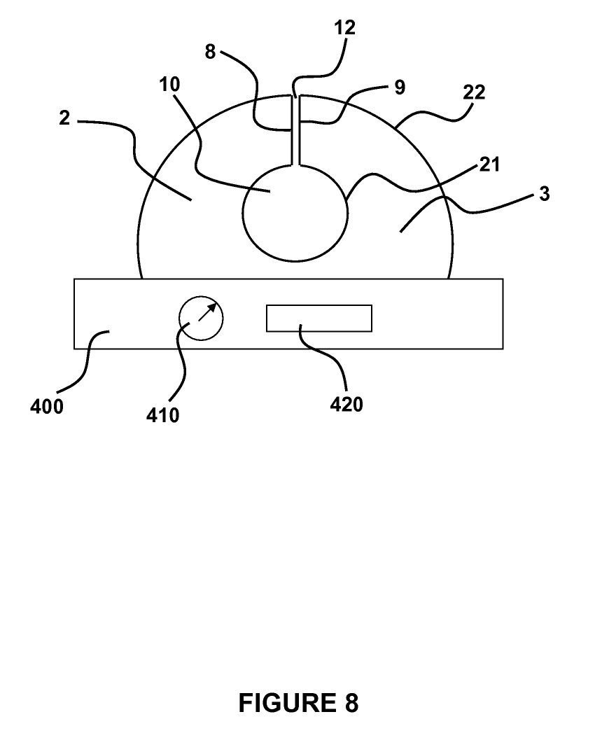

The frequency at which a metal resonates depends on the metal's temperature. Accordingly, a percussion instrument of the present invention can also be tuned by varying the temperature of the instrument by means known in the art. In one embodiment, temperature is controlled by temperature-controlled elements in proximity to the percussion instrument. Each of the one or more individual percussion instruments can be independently temperature controlled. The effect of temperature on the generated tone can be determined empirically to obtain a calibration curve of frequency as a function of temperature. In general, temperature can be varied to swing the tone about a half pitch to a pitch, or more depending on the instrument size. An advantage of temperature tuning is that the tone can be reversibly varied higher or lower. The abrasive method, although also bidirectional in that the frequency of the fundamental can be increased or decreased, involves shaving material from the base or wing ends and so is a more “permanent” means of tuning since that material cannot be readily replaced. Another advantage of temperature-controlled tuning is that a pair of the percussion instruments can be used in concert with temperature control to provide a wide range of beat generations corresponding to the different brain wave states. By having one instrument start cold, and the other instrument start hot, and then removing temperature regulation, the fundamental frequency of each of the pair will change with temperature so as to provide a beat or a binaural beat corresponding to a specific brain state. Providing more sophisticated temperature control, wherein the temperature can be controllably varied with time, permits a pair of the instruments to provide a beat whose frequency changes with time. FIG. 8 shows such a temperature regulator 400 with a temperature controller 410 and frequency display 420. Alternatively, the controller 410 and display 420 can be integrated into one dial-display. This can be useful, for example, for and during sleep so that just before sleep the brain is entrained to a relaxed state, and then entrained into theta and delta waves throughout the sleep cycle. Preferably, an automatic striker, as known in the art, periodically strikes the percussion instruments to generate the beat.

In one embodiment, seven shaped percussion instruments were constructed, with the fourth instrument tuned to D (at room temperature). The third and fifth instruments were tuned to 4 Hz below and above D. The second and sixth instruments were tuned to 6.5 Hz below and above D. The first and seventh instruments were tuned to 16.5 Hz below and above D.

The percussion instruments of this invention can be played and recorded, e.g., in stereo, to be played back to generate binaural beats.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

When a Markush group or other grouping is used herein, all individual members of the group and all combinations and subcombinations possible of the group are intended to be individually included in the disclosure. Whenever a range is given in the specification, for example, a temperature range, a time range, or size range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The definitions are provided to clarify their specific use in the context of the invention.

TABLE 1
Instrument Dimension and Sustained Tone Frequency

| Note | Piano | Freq | OD | Width | ID | FILLET 1 | FILLET 2 | FILLET3 |
|---|---|---|---|---|---|---|---|---|
| C7 | 76 | 2093.005 | 1.786 | 0.340 | 1.104 | 0.703 | 0.126 | 0.703 |
| B6 | 75 | 1975.533 | 1.892 | 0.360 | 1.170 | 0.745 | 0.134 | 0.745 |
| A#6 | 74 | 1864.655 | 2.005 | 0.382 | 1.239 | 0.789 | 0.142 | 0.789 |
| A6 | 73 | 1760.000 | 2.124 | 0.404 | 1.313 | 0.836 | 0.150 | 0.836 |
| G#6 | 72 | 1661.219 | 2.251 | 0.428 | 1.391 | 0.886 | 0.159 | 0.886 |
| G6 | 71 | 1567.982 | 2.384 | 0.454 | 1.474 | 0.939 | 0.169 | 0.939 |
| F#6 | 70 | 1479.978 | 2.526 | 0.481 | 1.562 | 0.995 | 0.179 | 0.995 |
| F6 | 69 | 1396.913 | 2.676 | 0.509 | 1.655 | 1.054 | 0.189 | 1.054 |
| E6 | 68 | 1318.510 | 2.836 | 0.540 | 1.753 | 1.116 | 0.200 | 1.116 |
| D#6 | 67 | 1244.508 | 3.004 | 0.572 | 1.857 | 1.183 | 0.212 | 1.183 |
| D6 | 66 | 1174.659 | 3.183 | 0.606 | 1.968 | 1.253 | 0.225 | 1.253 |
| C#6 | 65 | 1108.731 | 3.372 | 0.642 | 2.085 | 1.328 | 0.238 | 1.328 |
| C6 | 64 | 1046.502 | 3.573 | 0.680 | 2.209 | 1.407 | 0.252 | 1.407 |
| B5 | 63 | 987.767 | 3.785 | 0.720 | 2.340 | 1.490 | 0.267 | 1.490 |
| A#5 | 62 | 932.328 | 4.010 | 0.763 | 2.479 | 1.579 | 0.283 | 1.579 |
| A5 | 61 | 880.000 | 4.248 | 0.809 | 2.626 | 1.673 | 0.300 | 1.673 |
| G#5 | 60 | 830.609 | 4.501 | 0.857 | 2.783 | 1.772 | 0.318 | 1.772 |
| G5 | 59 | 783.991 | 4.769 | 0.908 | 2.948 | 1.878 | 0.337 | 1.878 |
| F#5 | 58 | 739.989 | 5.052 | 0.962 | 3.123 | 1.989 | 0.357 | 1.989 |
| F5 | 57 | 698.456 | 5.353 | 1.019 | 3.309 | 2.108 | 0.378 | 2.108 |
| E5 | 56 | 659.255 | 5.671 | 1.079 | 3.506 | 2.233 | 0.401 | 2.233 |
| D#5 | 55 | 622.254 | 6.008 | 1.144 | 3.714 | 2.366 | 0.425 | 2.366 |
| D5 | 54 | 587.330 | 6.366 | 1.212 | 3.935 | 2.506 | 0.450 | 2.506 |
| C#5 | 53 | 554.365 | 6.744 | 1.284 | 4.169 | 2.655 | 0.477 | 2.655 |
| C5 | 52 | 523.251 | 7.145 | 1.360 | 4.417 | 2.813 | 0.505 | 2.813 |
| B₄ | 51 | 493.883 | 7.570 | 1.441 | 4.680 | 2.981 | 0.535 | 2.981 |
| A#₄ | 50 | 466.164 | 8.020 | 1.527 | 4.958 | 3.158 | 0.567 | 3.158 |
| A₄ | 49 | 440.000 | 8.497 | 1.617 | 5.253 | 3.346 | 0.600 | 3.346 |
| G#₄ | 48 | 415.305 | 9.002 | 1.714 | 5.565 | 3.545 | 0.636 | 3.545 |
| G₄ | 47 | 391.995 | 9.538 | 1.815 | 5.896 | 3.755 | 0.674 | 3.755 |
| F#₄ | 46 | 369.994 | 10.105 | 1.923 | 6.247 | 3.979 | 0.714 | 3.979 |
| F₄ | 45 | 349.228 | 10.705 | 2.038 | 6.618 | 4.215 | 0.757 | 4.215 |
| E₄ | 44 | 329.628 | 11.342 | 2.159 | 7.012 | 4.466 | 0.802 | 4.466 |
| D#₄ | 43 | 311.127 | 12.016 | 2.287 | 7.428 | 4.732 | 0.849 | 4.732 |
| D₄ | 42 | 293.665 | 12.731 | 2.423 | 7.870 | 5.013 | 0.900 | 5.013 |
| C#₄ | 41 | 277.183 | 13.488 | 2.567 | 8.338 | 5.311 | 0.953 | 5.311 |
| C₄ | 40 | 261.626 | 14.290 | 2.720 | 8.834 | 5.627 | 1.010 | 5.627 |
| B₃ | 39 | 246.942 | 15.140 | 2.882 | 9.359 | 5.961 | 1.070 | 5.961 |
| A#₃ | 38 | 233.082 | 16.040 | 3.053 | 9.916 | 6.316 | 1.134 | 6.316 |
| A₃ | 37 | 220.000 | 16.994 | 3.235 | 10.505 | 6.691 | 1.201 | 6.691 |
| G#₃ | 36 | 207.652 | 18.004 | 3.427 | 11.130 | 7.089 | 1.272 | 7.089 |
| G₃ | 35 | 195.998 | 19.075 | 3.631 | 11.792 | 7.511 | 1.348 | 7.511 |
| F#₃ | 34 | 184.997 | 20.209 | 3.847 | 12.493 | 7.957 | 1.428 | 7.957 |
| F₃ | 33 | 174.614 | 21.411 | 4.075 | 13.236 | 8.431 | 1.513 | 8.431 |
| E₃ | 32 | 164.814 | 22.684 | 4.318 | 14.023 | 8.932 | 1.603 | 8.932 |
| D#₃ | 31 | 155.563 | 24.033 | 4.575 | 14.857 | 9.463 | 1.698 | 9.463 |
| D₃ | 30 | 146.832 | 25.462 | 4.847 | 15.740 | 10.026 | 1.799 | 10.026 |
| C#₃ | 29 | 138.591 | 26.976 | 5.135 | 16.676 | 10.622 | 1.906 | 10.622 |
| C₃ | 28 | 130.813 | 28.580 | 5.440 | 17.668 | 11.253 | 2.020 | 11.253 |
| B₂ | 27 | 123.471 | 30.280 | 5.764 | 18.719 | 11.923 | 2.140 | 11.923 |
| A#₂ | 26 | 116.541 | 32.080 | 6.106 | 19.832 | 12.632 | 2.267 | 12.632 |
| A₂ | 25 | 110.000 | 33.988 | 6.469 | 21.011 | 13.383 | 2.402 | 13.383 |
| G#₂ | 24 | 103.826 | 36.009 | 6.854 | 22.260 | 14.179 | 2.545 | 14.179 |
| G₂ | 23 | 97.999 | 38.150 | 7.262 | 23.584 | 15.022 | 2.696 | 15.022 |
| F#₂ | 22 | 92.499 | 40.419 | 7.693 | 24.986 | 15.915 | 2.856 | 15.915 |
| F₂ | 21 | 87.307 | 42.822 | 8.151 | 26.472 | 16.861 | 3.026 | 16.861 |
| E₂ | 20 | 82.407 | 45.368 | 8.636 | 28.046 | 17.864 | 3.206 | 17.864 |
| D#₂ | 19 | 77.782 | 48.066 | 9.149 | 29.714 | 18.926 | 3.397 | 18.926 |
| D₂ | 18 | 73.416 | 50.924 | 9.693 | 31.481 | 20.051 | 3.599 | 20.051 |
| C#₂ | 17 | 69.296 | 53.952 | 10.269 | 33.353 | 21.244 | 3.813 | 21.244 |
| C₂ | 16 | 65.406 | 57.160 | 10.880 | 35.336 | 22.507 | 4.039 | 22.507 |
| B₁ | 15 | 61.735 | 60.559 | 11.527 | 37.437 | 23.845 | 4.280 | 23.845 |
| A#₁ | 14 | 58.270 | 64.160 | 12.213 | 39.663 | 25.263 | 4.534 | 25.263 |
| A₁ | 13 | 55.000 | 67.976 | 12.939 | 42.022 | 26.765 | 4.804 | 26.765 |
| G#₁ | 12 | 51.913 | 72.018 | 13.708 | 44.521 | 28.357 | 5.089 | 28.357 |
| G₁ | 11 | 48.999 | 76.300 | 14.523 | 47.168 | 30.043 | 5.392 | 30.043 |
| F#₁ | 10 | 46.249 | 80.837 | 15.387 | 49.973 | 31.830 | 5.713 | 31.830 |
| F₁ | 9 | 43.654 | 85.644 | 16.302 | 52.944 | 33.722 | 6.052 | 33.722 |
| E₁ | 8 | 41.203 | 90.737 | 17.271 | 56.093 | 35.728 | 6.412 | 35.728 |
| D#₁ | 7 | 38.891 | 96.132 | 18.298 | 59.428 | 37.852 | 6.793 | 37.852 |
| D₁ | 6 | 36.708 | 101.848 | 19.386 | 62.962 | 40.103 | 7.197 | 40.103 |
| C#₁ | 5 | 34.648 | 107.904 | 20.539 | 66.706 | 42.488 | 7.625 | 42.488 |
| C₁ | 4 | 32.703 | 114.321 | 21.760 | 70.672 | 45.014 | 8.079 | 45.014 |
| B₀ | 3 | 30.868 | 121.119 | 23.054 | 74.875 | 47.691 | 8.559 | 47.691 |
| A#₀ | 2 | 29.135 | 128.321 | 24.425 | 79.327 | 50.526 | 9.068 | 50.526 |
| A₀ | 1 | 27.500 | 135.951 | 25.877 | 84.044 | 53.531 | 9.607 | 53.531 |

We claim:

1. A percussion instrument comprising:
a shaped piece of resonant material that generates a sustained tone when struck, said piece generally being shaped as an annular ring;
said ring having a flattened outer portion of its outer circumference to form a base; and
said ring having a gap therein opposite said base, said gap defining two symmetrical wings having flat opposed faces.

2. The percussion instrument of claim 1 further comprising a nodal passage through said instrument, said nodal passage capable of receiving means for suspending said instrument and said nodal passage located at a nodal point.

3. The percussion instrument of claim 1 further comprising
a pair of vibratory nodes on the base;
a groove located at each of the vibratory nodes for receiving an overtone damper.

4. The percussion instrument of claim 1 wherein the sustained tone is maintained for at least 10 minutes after a point on the non-flattened portion of outer circumference is struck.

5. The percussion instrument of claim 1 wherein said ring has an outer diameter OD an inner passage with an inner diameter ID according to the formula:
ID=OD(π/4)²

6. The percussion instrument of claim 5 wherein the central passage is tapered.

7. The percussion instrument of claim 5 wherein said ring comprises an outer surface that is orthogonally curved in a direction orthogonal to the circumference thereof.

8. The percussion instrument of claim 5 wherein said instrument has a maximum width T, according to the formula:
T=0.5(OD-ID).

9. The percussion instrument of claim 1 wherein the resonant material is brass or aluminum.

10. The percussion instrument of claim 1 wherein the sustained tone is a note of a standard musical scale.

11. The instrument of claim 1 wherein said instrument produces overtones substantially restricted to the third, fifth, twelfth, and fifteenth note above its fundamental.

12. The instrument of claim 2, wherein means for suspending said instrument comprises:
a pin fitted into said nodal hole;
a cord connected to an end of said pin; and
a stand having a stand hanger for receiving said cord.

13. A method of tuning the percussion instrument of claim 1 instrument comprising abrading the base to decrease the frequency of the sustained tone or abrading one or more opposing faces of said wings to increase the frequency of the sustained tone.

14. A method of tuning the percussion instrument of claim 1 comprising adjusting the temperature of the instrument thereby tuning the frequency of the fundamental tone.

15. A method of generating a tone from the percussion instrument of claim 1 comprising striking the outer circumference of the non-flattened portion of the ring.

16. A method of generating a beat comprising:
positioning a first percussion instrument of claim 1 relative to a second percussion instrument of claim 1, wherein said first and second instruments produce different tones;
striking the first percussion instrument to generate a first tone; and
striking the second percussion instrument to generate a second tone, thereby generating a beat.

17. A beat generator comprising:
a first percussion instrument of claim 1 capable of producing a first tone;
a second percussion instrument of claim 1 capable of producing a second tone, wherein the frequency of the first tone is different than the frequency of the second tone.

18. The beat generator of claim 17 wherein the frequency difference between the first tone and the second tone is between about 0.009 Hz and about 50 Hz.

19. The beat generator of claim 17 further comprising a temperature regulator to vary the temperature of at least one percussion instrument, thereby varying its frequency.
